(19) United States
(12) Patent Application Publication
(10) Pub. No.: US 2009/0219587 A1
(43) Pub. Date: Sep. 3, 2009

(54) SCANNER AND HOMING METHOD OF SCANNING MODULE THEREOF

(75) Inventors: Li-Kui Weng, New District (TW); Xiao-Bing Zhan, New District (TW)

Correspondence Address: BACON & THOMAS, PLLC, 625 SLATERS LANE, FOURTH FLOOR, ALEXANDRIA, VA, 22314-1176, US

(73) Assignee: Qisda Corporation, Taoyuan (TW)

(21) Appl. No.: 12/388,704

(22) Filed: Feb. 19, 2009

(30) Foreign Application Priority Data
Feb. 29, 2008 (TW) 97107194

(51) Int. Cl. H04N 1/047

(52) U.S. Cl. 358/497

(57) ABSTRACT

A scanner including a casing, a scanning platform, a scanning module and a positioning plate is provided. The scanning platform is embedded in the casing and exposes a surface to carry a to-be-scanned document. The scanning module is disposed under the scanning platform. The positioning plate disposed on an inner wall of the casing is adjacent to a top side of the scanning platform. The scanning module is for capturing images of the positioning plate and the inner wall and for identifying the image corresponding to one x-axis side of the positioning plate. The scanner defines a scanning start line according to the image corresponding to the x-axis side. The scanning module is moved from the scanning start line along a y-axis direction and captures an image of the to-be-scanned document. The x-axis side and the scanning start line are perpendicular to the y-axis direction perpendicular to the top side.

This application claims the benefit of Taiwan application Serial No. 97107194, filed Feb. 29, 2008, the subject matter of which is incorporated herein by reference.

### BACKGROUND OF THE INVENTION

1. Field of the Invention

The invention relates in general to a scanner and a homing method of a scanning module thereof, and more particularly to a scanner capable of homing and a homing method of a scanning module thereof.

2. Description of the Related Art

Along with the rapid advance in technology, the scanner application has become popular. The scanner includes a scanning platform and a scanning module. The scanning module is disposed under the scanning platform. When a user would like to scan a document, the document is placed on the scanning platform. Then, the scanning module is moved along a direction to capture the image of the document.

Generally speaking, the scanning module is homed to a specific position firstly before scanning begins so as to scan the document from a start line. Therefore, the complete contents of the document are captured by the scanning module. However, the scanning module is not always precisely homed to the specific position, so that the scanning module may only capture a partial image of the document or even capture the image of other object. Accordingly, the scanning quality of the scanner is reduced to lower the convenience in use.

Conventionally, a homing structure is used as a basis for homing a scanning module. Referring to FIG. 1, a conventional homing structure is shown. The homing structure 70 is used for being disposed on a casing (not illustrated) of a scanner (not illustrated). The homing structure 70 includes a white plate 71 and a black pattern 72 (the portion in FIG. 1 with slanting lines). The black pattern 72 covers the white plate 71 by a printing process. After a scanning module (not illustrated) of the scanner captures an image of the homing structure 70, the boundary between the black pattern 72 and the white plate 71 is used as a basis for homing the scanning module.

However, as the black pattern 72 covers the white plate 71 by the printing process which is complicated and costly, the disposition of black pattern 72 usually increases the cost and complexity in manufacturing the homing structure 70. Therefore, how to design a scanner capable of precisely homing to lower the cost and complexity in manufacturing and increase the scanning quality has become an imminent issue to the manufacturers.

### SUMMARY OF THE INVENTION

The invention is directed to a scanner and a homing method of a scanning module thereof. A positioning plate cooperates with a casing of the scanner to be used as a basis for homing the scanning module. Thus, the scanning module can be precisely homed, so that an image of a to-be-scanned document can be completely captured and the scanning quality is improved correspondingly. In addition, compared with a conventional homing structure, the positioning plate of the invention does not need to form any patterns thereon by a printing process. Therefore, the cost and complexity of the positioning plate of the invention in manufacturing are less than those of the conventional homing structure.

According to a first aspect of the present invention, a scanner including a casing, a scanning platform, a scanning module and a positioning plate is provided. The scanning platform is embedded in the casing and exposes a surface to carry a to-be-scanned document. The scanning platform includes a top side. The scanning module is disposed under the scanning platform. The positioning plate is disposed on an inner wall of the casing and is adjacent to the top side of the scanning platform. The scanning module is used for capturing images of the positioning plate and the inner wall and for identifying the image corresponding to at least one x-axis side of the positioning plate. A scanning start line is defined by the scanner according to the image corresponding to the x-axis side. The scanning module is moved from the scanning start line along a y-axis direction and captures an image of the to-be-scanned document. The x-axis side and the scanning start line are substantially perpendicular to the y-axis direction. The y-axis direction is substantially perpendicular to the top side.

According to a second aspect of the present invention, a homing method of a scanning module of a scanner is provided. The method includes the following steps. Firstly, images of a positioning plate and an inner wall of a casing of the scanner are captured. The positioning plate is disposed on the inner wall of the casing and is adjacent to a top side of the scanning platform of the scanner. Next, the image corresponding to at least one x-axis side of the positioning plate is identified. Then, a scanning start line is defined according to the image corresponding to the x-axis side. The scanning module is moved from the scanning start line along a y-axis direction and captures an image of a to-be-scanned document. The x-axis side and the scanning start line are substantially perpendicular to the y-axis direction. The y-axis direction is substantially perpendicular to the top side.

The invention will become apparent from the following detailed description of the preferred but non-limiting embodiments. The following description is made with reference to the accompanying drawings.

### BRIEF DESCRIPTION OF THE DRAWINGS

FIG. 1 (Prior Art) shows a conventional homing structure;

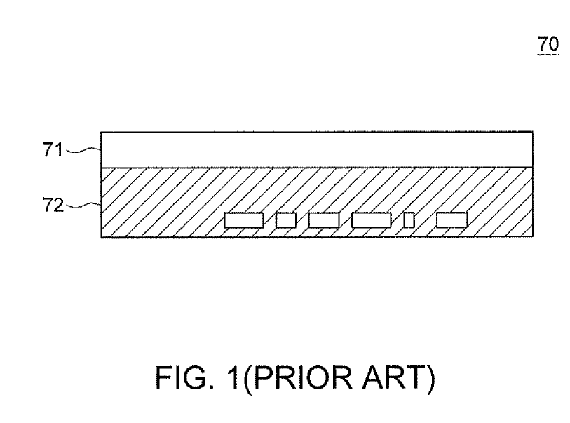

FIG. 2A shows a top view of a scanner according to a preferred embodiment of the invention;

FIG. 2B shows a cross-sectional view of the scanner taken along line 2B-2B in FIG. 2A;

FIG. 3A shows another positioning plate disposed in a recess of a casing;

FIG. 3B shows a cross-sectional view of the scanner taken along line 3B-3B in FIG. 3A;

FIG. 4A shows a top view of yet another positioning plate disposed on a casing of a scanner;

FIG. 4B shows a cross-sectional view of the scanner taken along line 4B-4B in FIG. 4A; and

FIG. 5 shows an example of a flowchart of a homing method of the scanning module in FIG. 2A.

### DETAILED DESCRIPTION OF THE INVENTION

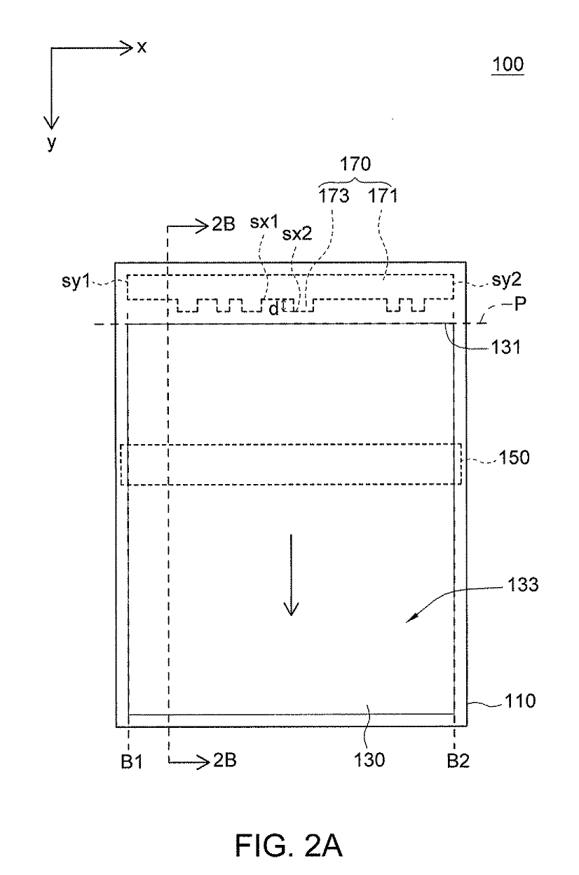

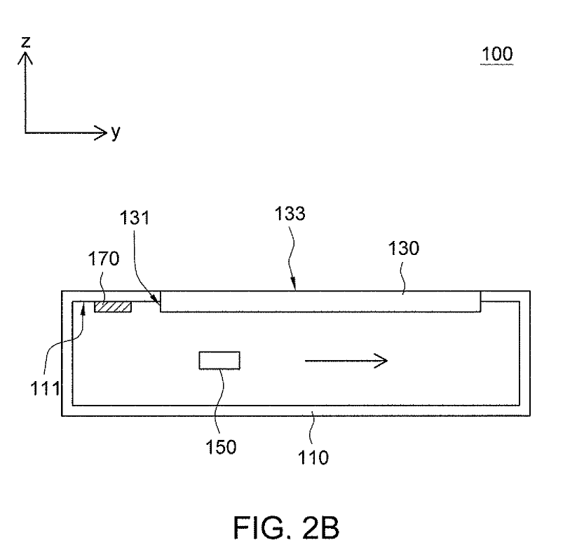

Referring to FIG. 2A and FIG. 2B, a top view of a scanner according to a preferred embodiment of the invention is shown in FIG. 2A, and a cross-sectional view of the scanner taken along line 2B-2B in FIG. 2A is shown in FIG. 2B. The scanner 100 includes a casing 110, a scanning platform 130, a scanning module 150 and a positioning plate 170. The scanning module 150 is, for example, a device including a charge-coupled device (CCD) or a device including a contact image sensor (CIS).

The scanning platform 130 is embedded in the casing 110 and exposes a surface 133 to carry a to-be-scanned document (not illustrated). The scanning platform 130 includes a top side 131. The scanning module 150 is disposed under the scanning platform 130. The positioning plate 170 is disposed on an inner wall 111 of the casing 110 and is adjacent to the top side 131 of the scanning platform 130. The scanning module 150 is used for capturing images of the positioning plate 170 and the inner wall 111 of the casing 110 and for identifying the image corresponding to at least one x-axis side of the positioning plate 170. It is illustrated in the following embodiment of the invention that the images identified by the scanning module 150 correspond to x-axis sides sx1 and sx2. A scanning start line P is defined by the scanner 100 according to the images corresponding to the x-axis sides sx1 and sx2. The scanning module 150 is moved from the scanning start line P along a y-axis direction and captures an image of the to-be-scanned document.

The relationships among the x-axis sides sx1 and sx2, the y-axis direction, the scanning start line P and the top side 131 are disclosed below. The x-axis sides sx1 and sx2 and the scanning start line P are substantially perpendicular to the y-axis direction. The y-axis direction is substantially perpendicular to the top side 131. In addition, the exemplified x-axis sides sx1 and sx2 are spaced at an interval d in the y-axis direction, but the invention is not limited thereto. The two x-axis sides used for defining the scanning start line P do not have to be separated in the y-axis direction.

Thus, through the cooperation of the positioning plate 170 and the inner wall 111 of the casing 110, the scanning module 150 of the scanner 100 can be homed precisely to be moved from the scanning start line P along the y-axis direction and completely capture the image of the to-be-scanned document.

The scanner 100 of the present embodiment of the invention is further elaborated below. As indicated in FIG. 2A, the positioning plate 170 has a body 171 and several rectangular structures 173 (only one of the rectangular structures is numbered in FIG. 2A). The rectangular structure 173 protrudes from the body 171 in the direction which is substantially parallel to the y-axis direction. The x-axis sides sx1 and sx2 are one side of the body 171 and one side of the rectangular structure 173, respectively. As the rectangular structure 173 protrudes from the body 171, the x-axis sides sx1 and sx2 are spaced at the interval d. Despite the x-axis sides sx1 and sx2 separated at the interval d are used as bases for homing the scanning module 150, the basis for homing the scanning module 150 in the present invention is not limited thereto. At least one x-axis side which is substantially perpendicular to the y-axis direction can be used as a basis for homing the scanning module 150.

In order to clearly identify the images corresponding to the x-axis sides sx1 and sx2 of the positioning plate 170, the color of the positioning plate 170 is different from that of the inner wall 111 of the casing 110. Thus, the scanning module 150 identifies the images corresponding to the x-axis sides sx1 and sx2 of the positioning plate 170 to be bases for homing according to the different colors between the positioning plate 170 and the inner wall 111. The color of the inner wall 111 of the casing 110 is, for example, gray or black, and the color of the positioning plate 170 is, for example, white. However, the invention is not limited thereto. Any colors enabling the scanning module 150 to clearly identify the image corresponding to the x-axis side of the positioning plate 170 can be used as the colors of the positioning plate 170 and the inner wall 111 of the casing 110.

Moreover, black calibration can be performed to the scanning module 150 according to the color characteristics of the inner wall 111 of the casing 110. Generally speaking, when black calibration is performed to a scanning module of a scanner, a light source of the scanner needs to be turned on or turned off. When black calibration is performed to the scanner 100 by way of turning on the light source, a luminosity of the inner wall 111 of the casing 110 needs to be smaller than a black default value (such as value 100 defined by firmware). Thus, when the color of the inner wall 111 of the casing 110 is selected, apart from enabling the scanning module 150 to identify the image corresponding to the x-axis side of the positioning plate 170, the condition that the inner wall 111 is applied to black calibration can also be taken into consideration. Accordingly, when the light source of the scanner 100 is turned on, black calibration can be performed to the scanning module 150 according to the luminosity of the inner wall 111.

According to the images of the positioning plate 170 and the inner wall 111 of the casing 110 captured by the scanning module 150, the scanning module 150 further identifies the images corresponding to the y-axis sides (such as the y-axis sides sy1 and sy2) of the positioning plate 170. The y-axis sides sy1 and sy2 are substantially perpendicular to the x-axis sides sx1 and sx2 and are respectively located at two sides of the positioning plate 170. The scanning module 150 is homed according to the images corresponding to the y-axis sides sy1 and sy2 so as to capture the image of the to-be-scanned document located between two boundaries such as boundaries B1 and B2. Thus, the condition that unnecessary images or only a portion of the contents of the to-be-scanned document are captured can be avoided.

Despite the present embodiment is exemplified by the positioning plate 170 in FIG. 2A, anyone who is skilled in the art will understand that the disposition or the shape of the positioning plate is not limited thereto. Any positioning plate enabling the scanning module to capture the image of the positioning plate as a basis for homing would do.

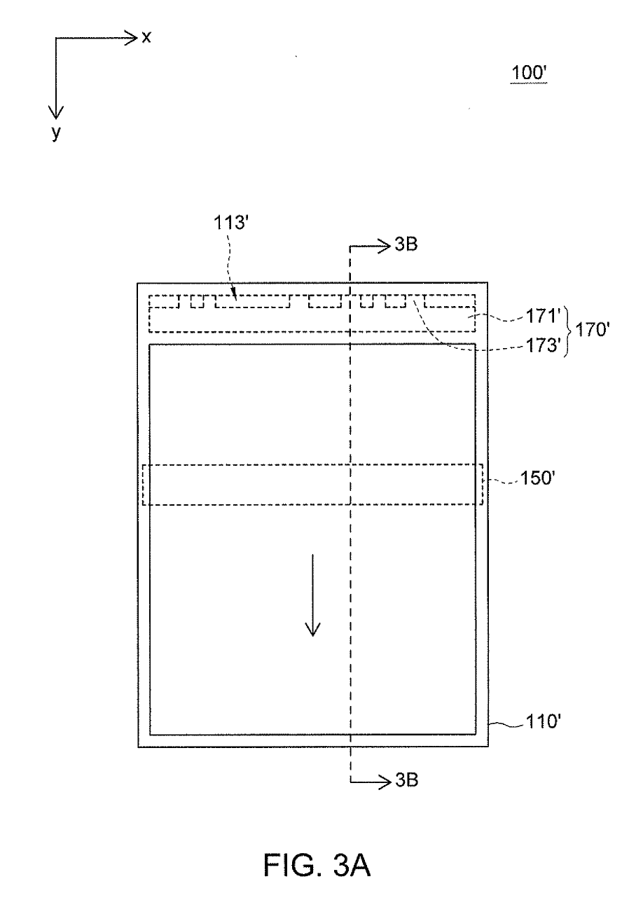

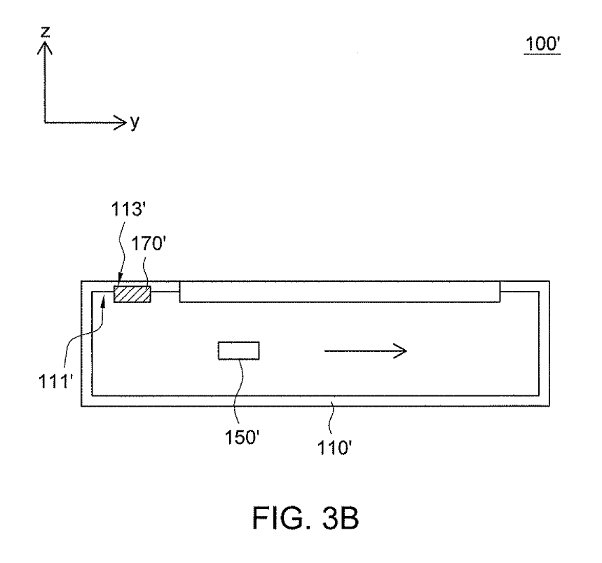

Referring to FIG. 3A and FIG. 3B, another positioning plate disposed in a recess of a casing is shown in FIG. 3A, and a cross-sectional view of the scanner taken along line 3B-3B in FIG. 3A is shown in FIG. 3B. The inner wall 111′ of the casing 110′ of the scanner 100′ has a recess 113′. Through the indentation design of the recess 113′, the positioning plate 170′ is precisely disposed in the recess 113′. Thus, the error in the homing of the scanning module 150′ caused by the position of the positioning plate 170′ can be reduced. Furthermore, the positioning plate 170′ can be disposed as indicated in FIG. 3A. That is, the direction that the rectangular structure 173′ protrudes from the body 171′ is different from the direction that the rectangular structure 173 (illustrated in FIG. 2A) protrudes from the body 171 (illustrated in FIG. 2A).

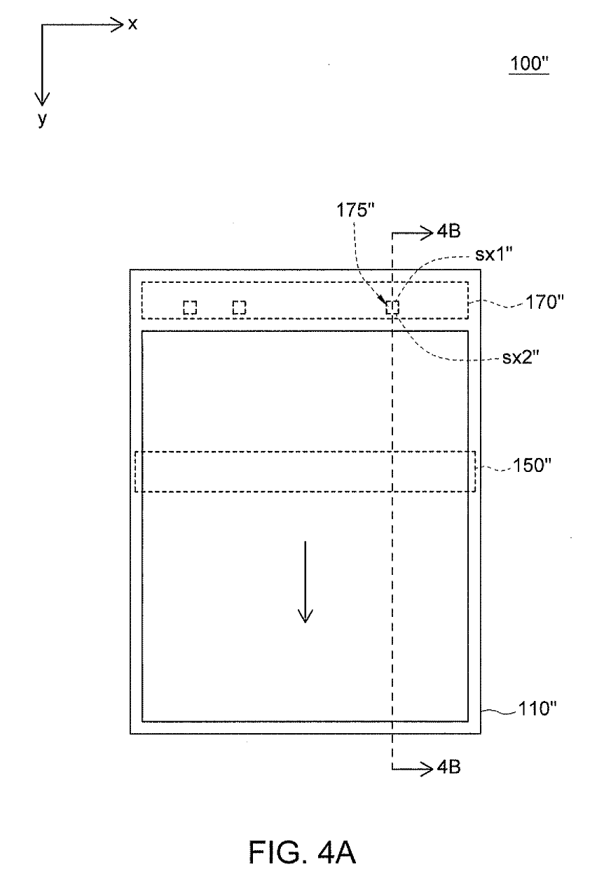

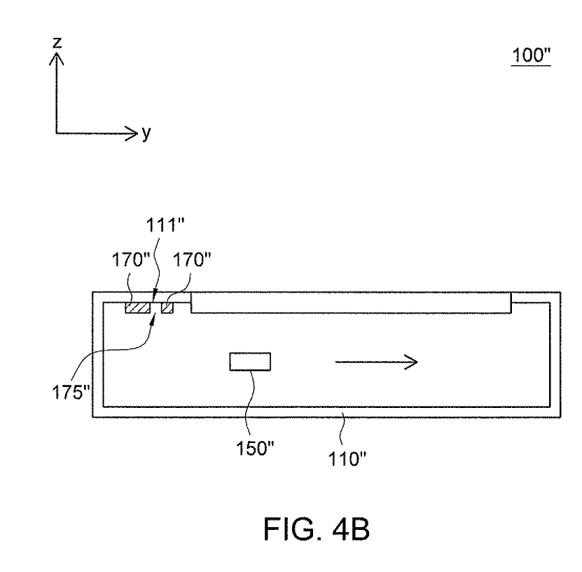

Referring to FIG. 4A and FIG. 4B, a top view of yet another positioning plate disposed on a casing of a scanner is shown in FIG. 4A, and a cross-sectional view of the scanner taken along line 4B-4B in FIG. 4A is shown in FIG. 4B. The positioning plate 170″ of the scanner 100″ has several square holes 175″ (only one of the square holes is numbered in FIG. 4A). The square hole 175″ penetrates the positioning plate 170″ so as to expose the inner wall 111″ of the casing 110″. The positioning plate 170″ further has four inner sides. At least one of the inner sides, such as the x-axis side sx1″ or the x-axis side sx2″, can be used as a basis for homing the scanning module 150″.

Apart from using the x-axis sides and the y-axis sides of the positioning plate as bases for homing, the scanning module can further use the ordinal number of the pixels of the captured image as a basis for homing. Thus, the homing of the scanning module is more precise so as to improve the homing precision.

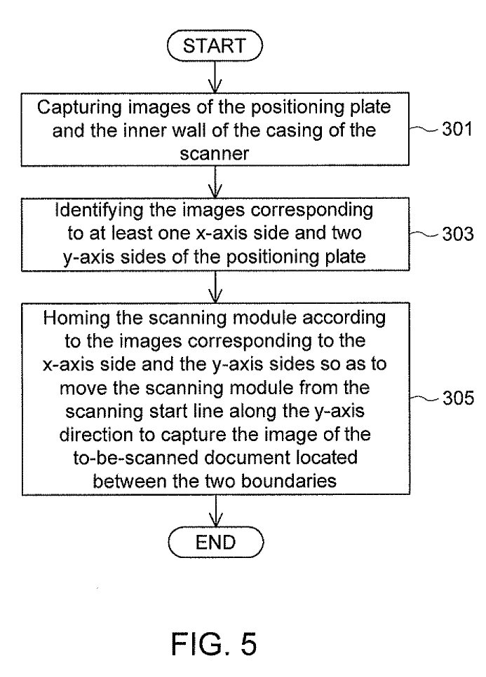

Please refer to FIG. 2A, FIG. 2B and FIG. 5 at the same time. FIG. 5 shows an example of a flowchart of a homing method of the scanning module in FIG. 2A. Despite the homing method of a scanning module of a scanner of the invention is exemplified by the scanner 100 in FIG. 2A and FIG. 2B and the flowchart in FIG. 5, anyone who is skilled in the art will understand that the steps and the sequence of the homing method of a scanning module of a scanner of the invention are not limited to that illustrated in the flowchart in FIG. 5.

In the following example of homing the scanning module 150, the scanning module 150 is moved from the scanning start line P along the y-axis direction and captures the image of the to-be-scanned document located between the two boundaries B1 and B2.

Firstly, in the step 301, the images of the positioning plate 170 and the inner wall 111 of the casing 110 of the scanner 100 are captured. As indicated in FIG. 2A, the positioning plate 170 has the body 171 and several rectangular structures 173. Thus, in the step 301, the images of the inner wall 111 of the casing 110 and the body 171 and the rectangular structure 173 of the positioning plate 170 are captured concurrently.

Next, in the step 303, the images corresponding to at least one x-axis side (such as the x-axis sides sx1 and sx2) and two y-axis sides (such as the y-axis sides sy1 and sy2) of the positioning plate 170 are identified. In the step 303, the images corresponding to the x-axis sides sx1 and sx2 and the y-axis sides sy1 and sy2 of the positioning plate 170 are identified according to the different colors of the positioning plate 170 and the inner wall 111 of the casing 110. The y-axis sides sy1 and sy2 are substantially perpendicular to the x-axis sides sx1 and sx2.

Then, in the step 305, the scanning module 150 is homed according to the images corresponding to the x-axis sides sx1 or sx2 and the y-axis sides sy1 and sy2 so as to move from the scanning start line P along the y-axis direction and capture the image of the to-be-scanned document located between the two boundaries B1 and B2.

The flowchart in FIG. 5 is merely an example of the homing method of the scanning module of the invention, and the invention is not limited thereto. The homing method of the scanning module of the invention can also be applied to the scanner in FIG. 3A or FIG. 4A for homing the scanning module.

According to the scanner and the homing method of the scanning module thereof disclosed in the above embodiment of the invention, the positioning plate cooperates with the inner wall of the casing so as to use the image corresponding to the side of positioning plate as a basis for homing the scanning module. Thus, the scanning module can be precisely homed, so that the image of a to-be-scanned document can be completely captured to improve the scanning quality correspondingly. Compared with conventional homing structure, the positioning plate of the embodiment does not need to form any patterns thereon by a printing process. Thus, the positioning plate of the embodiment has lower cost and complexity in manufacturing.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A scanner, comprising:
a casing;
a scanning platform embedded in the casing and exposing a surface to carry a to-be-scanned document, wherein the scanning platform comprises a top side;
a scanning module disposed under the scanning platform; and
a positioning plate disposed on an inner wall of the casing and adjacent to the top side of the scanning platform, wherein the scanning module is used for capturing images of the positioning plate and the inner wall and for identifying the image corresponding to at least one x-axis side of the positioning plate, a scanning start line is defined by the scanner according to the image corresponding to the x-axis side, and the scanning module is moved from the scanning start line along a y-axis direction and captures an image of the to-be-scanned document;
wherein, the x-axis side and the scanning start line are substantially perpendicular to the y-axis direction, and the y-axis direction is substantially perpendicular to the top side.

2. The scanner according to claim 1, wherein the scanning module identifies the image corresponding to the x-axis side according to the different colors between the positioning plate and the inner wall.

3. The scanner according to claim 1, wherein the positioning plate has a body and at least one rectangular structure, the rectangular structure protrudes from the body in the direction which is substantially parallel to the y-axis direction, and the x-axis side is a side of one of the rectangular structure and the body.

4. The scanner according to claim 1, wherein the positioning plate has at least one square hole, the square hole penetrates the positioning plate so as to expose the inner wall, the positioning plate further has four inner sides, and the x-axis side is one of the inner sides of the positioning plate.

5. The scanner according to claim 1, wherein the scanning module is further used for identifying the images corresponding to two y-axis sides of the positioning plate, the y-axis sides are substantially perpendicular to the x-axis side and are respectively located at two sides of the positioning plate, the scanning module is homed according to the images of the y-axis sides to capture the image of the to-be-scanned document located between two boundaries.

6. The scanner according to claim 1, wherein the inner wall has a recess, and the positioning plate is disposed in the recess.

7. The scanner according to claim 1, wherein a luminosity of the inner wall is smaller than a black default value, and the scanning module is further used for performing black calibration according to the luminosity of the inner wall.

8. A homing method of a scanning module of a scanner, comprising:
capturing images of a positioning plate and an inner wall of a casing of the scanner, wherein the positioning plate is disposed on the inner wall of the casing and is adjacent to a top side of a scanning platform of the scanner,
identifying the image corresponding to at least one x-axis side of the positioning plate; and
defining a scanning start line according to the image corresponding to the x-axis side, wherein the scanning module is moved from the scanning start line along a y-axis direction and captures an image of a to-be-scanned document;
wherein, the x-axis side and the scanning start line are substantially perpendicular to the y-axis direction, and the y-axis direction is substantially perpendicular to the top side.

9. The homing method according to claim 8, wherein in the identifying step, the image corresponding to the x-axis side is identified according to the different colors between the positioning plate and the inner wall.

10. The homing method according to claim 8, wherein the positioning plate has a body and at least one rectangular structure, the rectangular structure protrudes from the body in the direction which is substantially parallel to the y-axis direction, and the x-axis side is a side of one of the rectangular structure and the body.

11. The homing method according to claim 8, wherein the positioning plate has at least one square hole, the square hole penetrates the positioning plate so as to expose the inner wall, the positioning plate further has four inner sides, and the x-axis side is one of the inner sides of the positioning plate.

12. The homing method according to claim 8, wherein after the capturing step, the homing method further comprises:
identifying the images corresponding to two y-axis sides of the positioning plate, wherein the y-axis sides are substantially perpendicular to the x-axis side and are respectively located at two sides of the positioning plate; and
homing the scanning module according to the images of the y-axis sides so as to capture the image of the to-be-scanned document located between two boundaries.
